(19) United States
(12) Patent Application Publication
(10) Pub. No.: US 2020/0050314 A1
(43) Pub. Date: Feb. 13, 2020

(54) TOUCH SENSING METHOD, ELECTRONIC DEVICE AND NON-TRANSITORY COMPUTER READABLE RECORDING MEDIUM DEVICE

(71) Applicant: ASUSTeK COMPUTER INC., Taipei (TW)

(72) Inventors: Yao-Yu Tsai, Taipei (TW); Chun-Tsai Yeh, Taipei (TW); Yi-Ou Wang, Taipei (TW)

(21) Appl. No.: 16/392,799

(22) Filed: Apr. 24, 2019

(30) Foreign Application Priority Data
Aug. 7, 2018 (CN) 201810891833.X

(51) Int. Cl. G06F 3/041

(52) U.S. Cl. CPC G06F 3/0416; G06F 3/03547

(57) ABSTRACT

A touch sensing method is provided. The touch sensing method is applied to an electronic device with a touchable unit. The touch sensing method comprises the following steps: sensing a touch event by using the touchable unit; detecting a current operation mode; triggering a corresponding touch operation according to the touch event when the current operation mode is a touch recognition mode; determining whether the touch event is touch gesture input or key input when the current operation mode is a key recognition mode; triggering corresponding key operation according to the key input when the touch event is the key input; and triggering a corresponding touch operation according to the touch gesture input when the touch event is the touch gesture input.

### CROSS-REFERENCE TO RELATED APPLICATION

This application claims the priority benefit of China Application Serial No. 201810891833.X, filed on Aug. 7, 2018. The entirety of the above-mentioned patent application is hereby incorporated by reference herein and made a part of the specification.

### BACKGROUND OF THE INVENTION

### Field of the Invention

The invention relates to touch sensing technology.

### Description of the Related Art

In modern society with booming development of information, dependency of the public on electronic devices increases day by day. Especially, portable electronic device is indispensable in the daily life of people.

In general, electronic devices have man-machine interfaces for users to communicate with. Taking a notebook computer as an example, the man-machine input interfaces generally include keyboards and touchable units. Therefore, users can input information via the keyboard, and perform a touch operation via the touchable unit to operate the notebook. However, in order to accommodate the keyboard in a small dimension of a notebook computer, the independent number keys are often omitted in a notebook keyboard which results inconvenience.

### BRIEF SUMMARY OF THE INVENTION

According to the first aspect, a touch sensing method applied to an electronic device with a touchable unit is provided. The touch sensing method comprises the following steps: sensing a touch event by the touchable unit; detecting a current operation mode; triggering a corresponding touch operation according to the touch event when the current operation mode is a touch recognition mode; determining whether the touch event is touch gesture input or key input when the current operation mode is a key recognition mode; triggering a corresponding key operation according to the key input when determining that the touch event is the key input; and triggering a corresponding touch operation according to the touch gesture input when determining that the touch event is the touch gesture input.

According to the second aspect of the disclosure, an electronic device is provided herein. The electronic device comprises: a touchable unit, configured to sense a touch event; and a processor, configured to detect a current operation mode, wherein the processor triggers a corresponding touch operation according to the touch event when the current operation mode is a touch recognition mode, and, the processor determines whether the touch event is touch gesture input or key input when the current operation mode is a key recognition mode; the processor triggers a corresponding key operation according to the key input when the touch event is the key input, and the processor triggers a corresponding touch operation according to the touch gesture input when the touch event is the touch gesture input. According to the third aspect of the disclosure, a non-transitory computer readable recording medium device is provided herein. The non-transitory computer readable recording medium device stores at least one program and when an electronic device loads and executes the at least one program, the at least one program enables the electronic device to execute the following steps: sensing a touch event by the touchable unit; detecting a current operation mode; triggering a corresponding touch operation according to the touch event when the current operation mode is a touch recognition mode; determining whether the touch event is touch gesture input or key input when the current operation mode is a key recognition mode; triggering a corresponding key operation according to the key input when determining that the touch event is the key input; and triggering a corresponding touch operation according to the touch gesture input when determining that the touch event is the touch gesture input.

The detailed descriptions of other effects and embodiments of the invention are provided below with reference to the accompanying drawings.

### BRIEF DESCRIPTION OF THE DRAWINGS

To more clearly describe the technical solutions in the embodiments of this application or in the prior art, the following will briefly introduce the drawings required for describing the embodiments or the prior art. It is apparent that the drawings in the following description are only some embodiments described in this application, and a person of ordinary skill in the art may obtain other drawings on the basis of these drawings without any creative effort.

FIG. 1 is a block general schematic diagram of an embodiment of an electronic device;

FIG. 2 is a general schematic diagram of an embodiment when a touchable unit of the electronic device is in a touch mode;

FIG. 3 is a general schematic diagram of an embodiment when the touchable unit of the electronic device is in a key mode;

FIG. 4 is a general schematic diagram of an embodiment of a system structure in the electronic device;

FIG. 5 is a flow schematic diagram of an embodiment of a touch sensing method;

FIG. 6 is a general schematic diagram of another embodiment of the system structure in the electronic device; and

FIG. 7 is a flow schematic diagram of another embodiment of the touch sensing method.

### DETAILED DESCRIPTION OF THE EMBODIMENTS

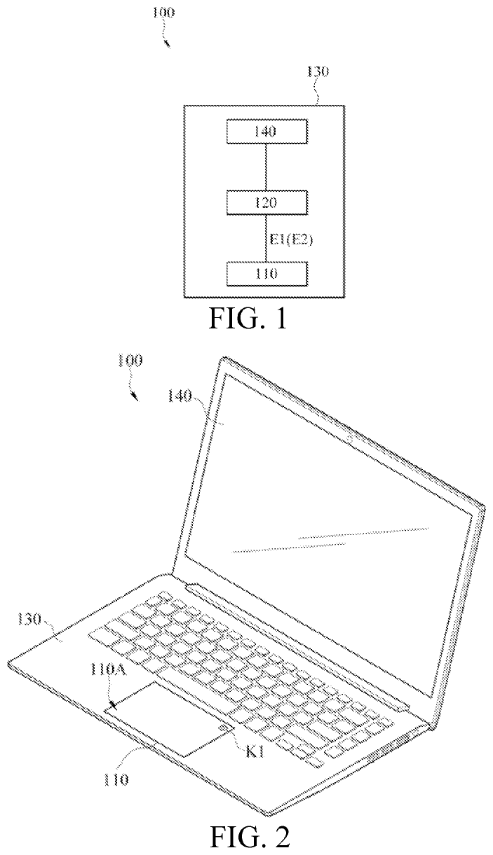

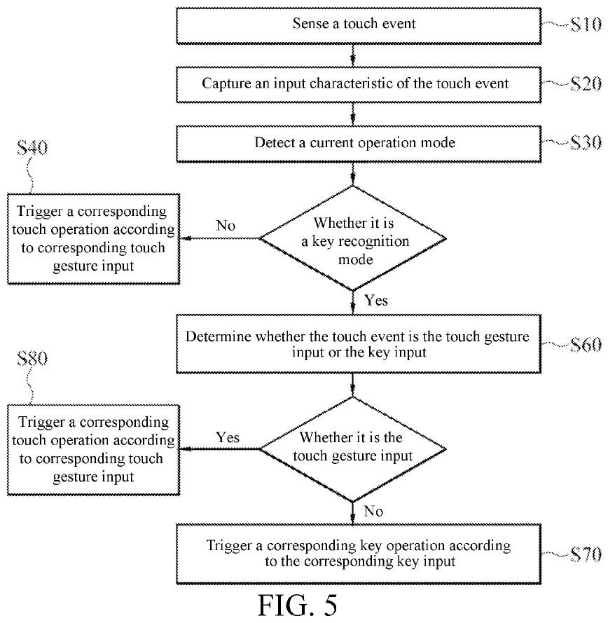

Referring to FIG. 1 to FIG. 5, the touch sensing method of any embodiment is implemented in an electronic device 100, so that the electronic device 100 senses input of a user. The electronic device 100 comprises a touchable unit 110 and a processor 120 coupled to the touchable unit 110. In an embodiment, the touchable unit 110 is a touch input device or a touch sensing device such as a touch screen or a touchpad, but the disclosure is not limited thereto.

In an embodiment, the touchable unit 110 is provided in a housing 130 of the electronic device 100, and a touch plane 110A of the touchable unit 110 is exposed to the surface of the housing 130 of the electronic device 100 for operation, but the disclosure is not limited thereto. In another embodiment, the touchable unit 110 is externally connected to the electronic device 100. In an embodiment, the electronic device 100 comprises a display 140 coupled to the processing unit 120. In an embodiment, the information input by the user via the touchable unit 110 is displayed by the display 140.

In an embodiment, the processor 120 comprises a processing module 121. The processing module 121 has a touch recognition mode and a key recognition mode.

Furthermore, the touch recognition mode is set as the initial operation mode of the processing module 121 by an operating system OS.

In an embodiment, the touchable unit 110 has a touch mode and a key mode. In an embodiment, the touch mode of the touchable unit 110 is corresponding to the touch recognition mode of the processing module 121, and the key mode of the touchable unit 110 is corresponding to the key recognition mode of the processing module 121. In other words, when the processing module 121 operates in the touch recognition mode, the touchable unit 110 correspondingly operates in the touch mode, and when the processing module 121 operates in the key recognition mode, the touchable unit 110 correspondingly operates in the key mode.

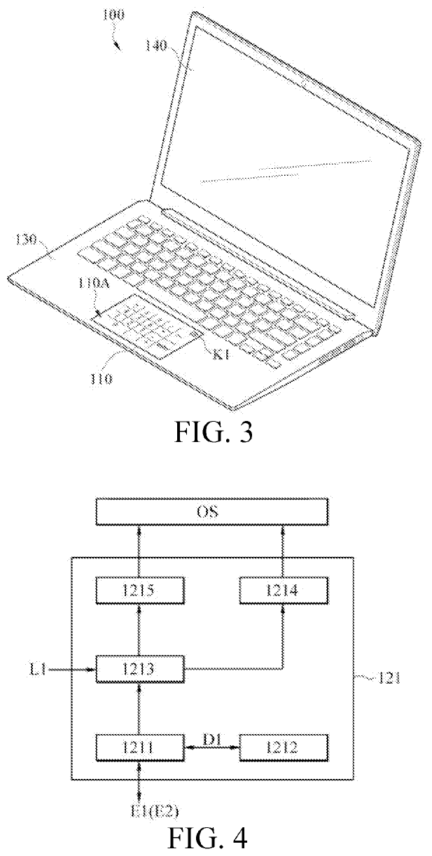

In an embodiment, when the touchable unit 110 operates in the key mode, the touchable unit 110 displays multiple preset key patterns and partition lines thereof, these preset key patterns are, but not limited to, operation symbols including Arabic numbers 0-9, decimal point, plus sign, subtraction sign, product sign, division sign and equality sign, or symbols representing functions of enter and backspace, so as to simulate the configuration of the keyboard, as shown in FIG. 3. Furthermore, when the touchable unit 110 operates in the touch mode, no preset key pattern and partition line is displayed on the touchable unit 110, as shown in FIG. 2.

In an embodiment, the electronic device 100 senses a touch event E1 by the touchable unit 110 (step S10), and the processing module 121 of the electronic device 100 receives the touch event E1 from the touchable unit 110. In an embodiment, the touch event E1 is a touch gesture.

In an embodiment, when the processing module 121 receives the touch event E1 from the touchable unit 110, the processing module 121 processes the touch event E1 for subsequent use (step S20). In some embodiments, when the processing module 121 receives the touch event E1 by executing a drive program 1211, an input characteristic D1 of the touch event E1 is captured by a preset capture program 1212. In an embodiment, the captured input characteristic D1 includes input position, packaging quantity, sliding distance, sliding time, clicking time interval or a combination thereof, but the disclosure is not limited thereto. In other embodiment, the input characteristic is any parameter applicable for determination.

In an embodiment, when the processing module 121 receives the touch event E1 from the touchable unit 110, the processing module 121 detects the current operation mode for determining the touch event E1 accordingly (step S30). When the processing module 121 detects that the current operation mode is the touch recognition mode, the processing module 121 determines that the touch event E1 sensed by the touchable unit 110 at the moment is a touch gesture input, and triggers a corresponding touch operation according touch event E1 (step S40). When the processing module 121 detects that the current operation mode is the key recognition mode, the processing module 121 further determines that the touch event E1 is touch gesture input or key input to trigger corresponding operation (step S60). When the processing module 121 determines that the touch event E1 is the key input, the processing module 121 triggers a corresponding key operation (step S70). When the processing module 121 determines that the touch event E1 is the touch gesture input, the processing module 121 triggers a corresponding touch operation (step S80). Therefore, when the processing module 121 operates in the key recognition mode, the user directly and rapidly performs touch gesture input or key input without switching the operation mode of the processing module 121.

In some embodiments, the processing module 121 determines the current operation mode by executing a determination program 1213. When the determination program 1213 determines that the current operation mode is the touch recognition mode, the determination program 1213 directly outputs the touch event E1 or the input characteristic D1 captured from the touch event E1 by the capture program 1212 to a touch data processing program 1214, and the touch data processing program 1214 outputs the touch event E1 or the input characteristic D1 to the operating system OS to perform a corresponding touch operation. When determining that the current operation mode is the key recognition mode, the determination program 1213 further determines that the touch event E1 is key input or touch gesture input. In this embodiment, when the determination program 1213 receives the input characteristic D1 captured from the touch event E1 by the capture program 1212 and determines that the touch event E1 is the key input according to the input characteristic D1, the determination program 1213 outputs the input characteristic D1 to a key data processing program 1215, and then the key data processing program 1215 outputs the input characteristic D1 to the operating system OS to perform a corresponding key operation. When the determination program 1213 determines that the touch event E1 is the touch gesture input according to the input characteristic D1, the determination program 1213 directly outputs the touch event E1 or the input characteristic D1 to the touch data processing program 1214, and then the touch data processing program 1214 outputs the input characteristic D1 to the operating system OS to perform a corresponding touch operation.

In some embodiments, the touch gesture input is dragging gesture or click input, but the disclosure is not limited thereto. In some embodiments, the touch gesture input is dragging gesture. In one embodiment, the dragging gesture is a single-finger sliding input or a double-finger sliding input. In an embodiment, a cursor displayed on the display 140 moves along the sliding track of the single-finger sliding input. In an embodiment, a picture displayed on the display 140 is rolled or zoomed according to the double-finger sliding input. In other embodiment, the touch gesture input is the click input or double click input, and a selecting function or a starting function is triggered by the click input or the double click input, but the disclosure is not limited thereto.

In some embodiments, the key input is pressing a specific region of the touchable unit 110, in an embodiment, a character is outputted or a key function is executed by pressing the specific region of the touchable unit 110. Therefore, in an embodiment of step S70, the processing module 121 obtains the input position of the key input according to the input characteristic D1, and outputs a character or a key function corresponding to the input position. In an embodiment, when the input position of the key input is corresponding to the character “6”, the processing module 121 enables the operating system OS to output the character “6” on the display 140. In another embodiment, when the input position of the key input is corresponding to the key function such as the backspace function, the processing module 121 enables the operating system OS to execute the backspace function and display the backspace picture on the display 140.

In some embodiment, the determination program 1213 determines whether the touch event E1 is the key input according to determining whether the packaging quantity of the input characteristic D1 exceeds a preset packaging quantity. When the packaging quantity of the input characteristic D1 exceeds the preset packaging quantity, the determination program 1213 determines that the touch event E1 is the continuous output action of the key input to trigger a corresponding key operation. In an embodiment, when the touch event E1 is the continuous output action of the key input, the determination program 1213 outputs the input characteristic D1 of the touch event E1 to the key data processing program 1215, and the key data processing program 1215 outputs the input characteristic D1 to the operating system OS. After that, character or key function corresponding to the input position of the key input is continuously output on the display 140. In some embodiments, the preset packaging quantity is between 60 and 70 such as 65, but the disclosure is not limited thereto; and the preset packaging quantity is determined by the designer.

In some embodiments, the processing module 121 operating in the key recognition mode determines whether the touch event E1 is the touch gesture input according to whether a sliding distance of the input characteristic D1 exceeds a specific logical dot size by the determination program 1213. When the sliding distance of the input characteristic D1 exceeds the specific logical dot size, the determination program 1213 determines that the touch event E1 is the touch gesture input and outputs the touch event E1 to the touch data processing program 1214, and then the touch data processing program 1214 outputs the touch event E1 to the operating system OS to control a cursor displayed on the display 140 to move along a sliding track of the touch gesture input sensed by the touchable unit 110. In some embodiments, the specific logical dot size is between 350 logical dots and 450 logical dots, but the disclosure is not limited thereto. In other embodiment, the specific logical dot size is determined by the designer.

In some embodiments, after the processing module 121 operating in the key recognition mode determines that the touch event E1 as the touch gesture input is ended (for example, the user raises a finger touching on the touchable unit 110 to end the touch event E1), the processing module 121 starts to count a time interval until receiving second touch event E2. Furthermore, the processing module 121 determines whether the second touch event E2 and the touch event E1 belong to the same touch gesture input according to whether the time interval is shorter than an interval threshold value. When the time interval is shorter than or equal to the interval threshold value, the processing module 121 determines that the second touch event E2 and the touch event E1 belong to the same touch gesture input to trigger a corresponding touch operation. Otherwise, when the time interval is longer than the interval threshold value, the processing module 121 determines that the second touch event E2 is the key input to trigger a corresponding key operation. In some embodiments, the interval threshold value is between 250 milliseconds and 350 milliseconds, but the disclosure is not limited thereto. In other embodiment, the interval threshold value is determined by the designed.

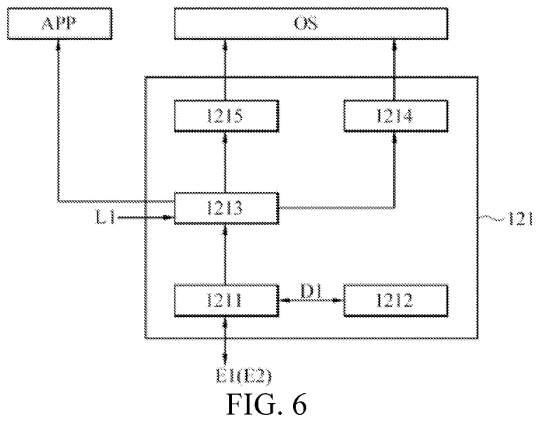

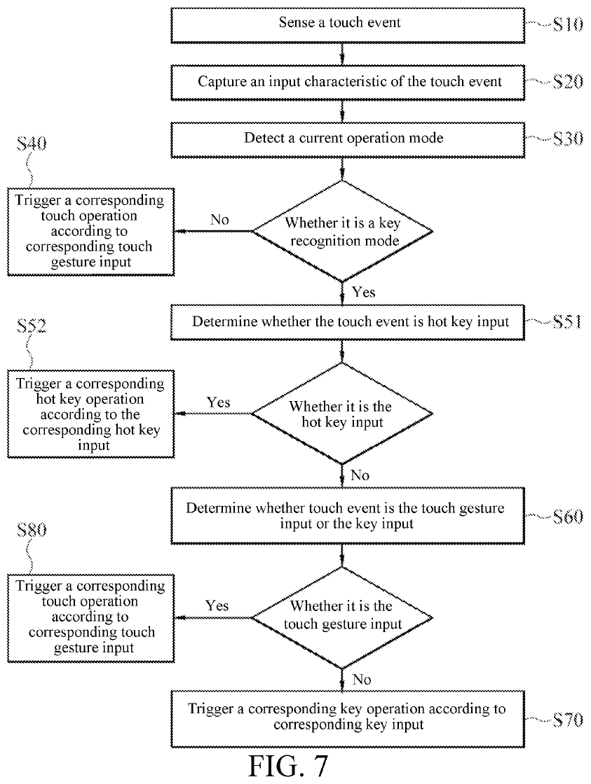

Referring to FIG. 1 to FIG. 7, in an embodiment, before step S60, the processing module 121 determines whether the touch event E1 is hot key input (step S51). When the processing module 121 determines that the touch event E1 is the hot key input, the processing module 121 triggers a corresponding hot key operation according to the hot key input (step S52). When the processing module 121 determines that the touch event E1 is not the hot key input, the processing module 121 executes step S60. In other words, the priority of the hot key input is higher than the priority of the touch gesture input and the key input.

In some embodiments, when the processing module 121 determines that the current operation mode is the key recognition mode by executing the determination program 1213, the determination program 1213 determines whether the touch event E1 is the hot key input according to the input characteristic D1 captured from the touch event E1. When the determination module 1213 determines that the touch event E1 is the hot key input, the processing module 121 executes a corresponding application program APP accordingly. When the determination program 1213 determines that the touch event E1 is not the hot key input, the determination program 1213 determines whether the touch event E1 is the touch gesture input or the key input.

In some embodiments, the hot key input is a specific gesture pattern for a specific function, and the hot key operation is to execute the specific function corresponding to the specific gesture pattern. In an embodiment, the specific gesture pattern is pattern “C” and the corresponding specific function is executing a computer application program, when the processing module 121 determines that the touch event E1 conforms to the pattern “C” according to the input characteristic D1 captured in step S20 (that is, the processing module 121 determines that the touch event E1 is the hot key input), the processing module 121 executes the computer application program and enables the display 140 to display the computer application program. In another embodiment, the specific gesture pattern is pattern “M” and the corresponding specific function is triggering a macro menu, and when the processing module 121 determines that the touch event E1 conforms to the pattern “M” according to the input characteristic D1 captured in step S20 (that is, the processing module 121 determines that the touch event E1 is the hot key input), the processing module 121 triggers the macro menu and enables the display 140 to display the macro menu. When the display 140 displays the macro menu, the user executes an application program by inputting a corresponding numerical code in the micro menu or executes an application program by directly clicking an icon of the application program in the macro menu.

In some embodiments, the specific gesture pattern of each hot key input and the corresponding specific function are designed and established by the user.

In an embodiment, the processing module 121 detects a switching signal L1 to determine whether to switch the operation mode. In some embodiments, when the processing module 121 detects the switching signal L1, the processing module 121 starts to accumulate an existence characteristic value (in an embodiment, the existence characteristic value is existence time or received package quantity) of the switching signal L1. When the existence characteristic value reaches is accumulated to a characteristic value threshold, the processing module 121 switches the operation mode from the current operation mode to the other operation mode, so as to confirm whether the user wants to switch operation mode in deed. In an embodiment, when the current operation mode is the touch recognition mode and the existence characteristic value of the switching signal L1 is accumulated to the characteristic value threshold, the processing module 121 switches the operation mode from the touch recognition mode to the key recognition mode. Otherwise, when the current operation mode is the key operation mode and the existence characteristic value of the switching signal L1 accumulated to the characteristic value threshold, the processing module 121 switches the operation mode from the key operation mode to the touch recognition mode. In an embodiment, when the characteristic value threshold is a time threshold, the characteristic value threshold is between 10 seconds and 20 seconds, but the disclosure is not limited thereto. In other embodiment, the characteristic value threshold is adjusted by the designed according to application situations. In an embodiment, in order to achieve rapid switching, the characteristic value threshold is set as zero, so that the processing module 121 immediately switches the operation mode while detecting the switching signal L1.

In some embodiments, the switching signal L1 is generated by pressing a preset switching key K1. The switching key K1 is a physical key or a virtual key. In addition, the switching key K1 is set in a key position of the touchable unit 110, as shown in FIG. 2, but the disclosure is not limited thereto.

In some embodiments, the processing module 121 notifies the user that the operation mode has been switched by a specific prompting mode. In an embodiment, when the processing module 121 switches from the key recognition mode to the touch recognition mode, the user is notified by turning off display of the key pattern or the partition lines on the touchable unit 110. In other embodiment, the processing module 121 notifies the user by popping up a prompt message in the display picture of the display 140. In other embodiment, the processing module 121 notifies the user by producing a prompt sound by a speaker of the electronic device 100, but the prompt manner is not limited thereto.

In an embodiment, in the key mode, while idling for a period of time, multiple preset key patterns and partition lines originally displayed on the touchable unit 110 are not displayed temporarily, so as to save electric power, and then multiple preset key patterns and partition lines are displayed again when the user touches the touchable unit 110 again.

In an embodiment, the touch sensing method of any embodiment of the disclosure is achieved by a non-transitory computer readable recording medium device. The non-transitory computer readable recording medium device stores at least one program, and when the electronic device 100 loads and executes the at least one program, the at least one program enables the electronic device 100 to execute the touch sensing method of any of the abovementioned control methods. In an embodiment, the non-transitory computer readable recording medium device is a memory in the electronic device 100. In some embodiments, the memory is achieved by one or more storage elements, and the storage elements are including read-only memory or flash memory. In another embodiment, the non-transitory computer readable recording medium device is a remote storage element and connected to the electronic device 100 in a wired or wireless manner. In further another embodiment, the non-transitory computer readable recording medium device is a memory outside the electronic device 100, and the program code of the memory is accessed by a reader or a connector of the electronic device 100.

In some embodiments, the display 140 is any suitable display screen, including an LCD screen or an LED screen. The processor 120 is a SoC wafer, a central processing unit (CPU), a microprogrammed control unit (MCU) or an application-specific integrated circuit (ASIC). The touchable unit 110 is a capacitive touch display screen, a resistive touch display screen or other touchable units made by using proper touch sensing elements. Moreover, the electronic device 100 is a notebook computer, a tablet computer, a smartphone or other suitable electronic devices, but the disclosure is not limited thereto.

To sum up, the touch sensing method, the electronic device and the non-transitory computer readable recording medium device according to the embodiments of the disclosure are capable of triggering a corresponding touch operation or key operation according to whether the touch event is the touch gesture input or the key input in the key recognition mode, so that the user performs the touch gesture input and the key input alternately more directly and rapidly without pressing a switching key.

The above-described embodiments and/or implementations are merely illustrative of preferred embodiments and/or implementations for practicing the techniques of the disclosure, and are not intended to limit the embodiments of the techniques of the disclosure in any manner, and any person skilled in the art may make various variations or modifications to obtain other equivalent embodiments without departing from the scope of the technical means disclosed herein, and all such embodiments should still be considered to be substantially the same techniques or embodiments as the disclosure.

1. A touch sensing method, applied to an electronic device, wherein the electronic device with a touchable unit, and the touch sensing method comprises:
sensing a touch event by the touchable unit;
detecting a current operation mode;
triggering a corresponding touch operation according to the touch event when the current operation mode is a touch recognition mode;
determining whether the touch event is hot key input when the current operation mode is a key recognition mode, wherein the hot key input comprises a specific gesture pattern for a specific function;
triggering a corresponding hot key operation according to the corresponding hot key input when the touch event is the hot key input;
determining whether the touch event is touch gesture input or key input when the touch event is not the hot key input;
triggering a corresponding key operation according to the key input when determining that the touch event is the key input; and
triggering a corresponding touch operation according to the touch gesture input when determining that the touch event is the touch gesture input.

2. (canceled)

3. The touch sensing method according to claim 1, further comprising:
detecting a switching signal;
accumulating an existence characteristic value of the switching signal; and
switching to the touch recognition mode or the key recognition mode according to the current operation mode when the existence characteristic value reaches a characteristic value threshold.

4. The touch sensing method according to claim 1, wherein the step of triggering the corresponding key operation according to the key input comprises:
obtaining the input position of the key input; and
outputting characters or key functions corresponding to the input position.

5. The touch sensing method according to claim 1, wherein the touch gesture input includes dragging gesture or clicking input.

6. An electronic device, comprising:
a touchable unit, configured to sense a touch event; and
a processor, configured to detect a current operation mode, wherein the processor triggers a corresponding touch operation according to the touch event when the current operation mode is a touch recognition mode, wherein the processor determines whether the touch event is hot key input when the current operation mode is a key recognition mode, wherein the hot key input comprises a specific gesture pattern for a specific function, wherein the processor triggers a corresponding hot key operation according to the corresponding hot key input when the touch event is the hot key input; wherein the processor determines whether the touch event is touch gesture input or key input when the touch event is not the hot key input, wherein the processor triggers a corresponding key operation according to the key input when the touch event is the key input, and wherein the processor triggers a corresponding touch operation according to the touch gesture input when the touch event is the touch gesture input.

7. (canceled)

8. The electronic device according to claim 6, wherein the processor further detects a switching signal, and accumulates an existence characteristic value of the switching signal, and when the existence characteristic value reaches a characteristic value threshold, the processor switches the touch recognition mode or the key recognition mode to the other one according to the current operation mode.

9. The electronic device according to claim 6, wherein the touch gesture input includes dragging gesture or clicking input.

10. A non-transitory computer readable recording medium device, storing at least one program, and when an electronic device loads and executes the at least one program, the at least one program enables the electronic device to execute the following steps:
sensing a touch event;
detecting a current operation mode;
triggering a corresponding touch operation according to the touch event when the current operation mode is a touch recognition mode;
determining whether the touch event is hot key input when the current operation mode is a key recognition mode, wherein the hot key input comprises a specific gesture pattern for a specific function;
triggering a corresponding hot key operation according to the corresponding hot key input when the touch event is the hot key input;
determining whether the touch event is touch gesture input or key input when the touch event is not the hot key input;
triggering a corresponding key operation according to the key input when determining that the touch event is the key input; and
triggering a corresponding touch operation according to the touch gesture input when determining that the touch event is the touch gesture input.
